(19) United States
(12) Patent Application Publication
(10) Pub. No.: US 2026/0162214 A1
(43) Pub. Date: Jun. 11, 2026

(54) INFORMATION PROCESSING APPARATUS, METHOD, AND STORAGE MEDIUM

(71) Applicant: CANON KABUSHIKI KAISHA, Tokyo (JP)

(72) Inventors: HIROKI WATABE, Tokyo (JP); MASATOSHI ISHII, Tokyo (JP)

(21) Appl. No.: 19/397,624

(22) Filed: Nov. 21, 2025

(30) Foreign Application Priority Data
Dec. 5, 2024 (JP) 2024-212240

(51) Int. Cl. G06T 3/40; G06F 3/01

(52) U.S. Cl. CPC G06T 3/40; G06F 3/013

(57) ABSTRACT

An information processing apparatus includes a setting unit that sets a resolution of rendering such that the resolution of rendering differs between a region depending on a line of sight of a user to a screen and another region, a rendering unit that renders an image to be displayed on the screen, depending on the set resolution of rendering, and a state determining unit that determines whether capturing of the image that is displayed on the screen is being performed. In a case where the state determining unit determines that the capturing is being performed, the setting unit cancels a setting of the resolution of rendering for the region depending on the line of sight of the user and the other region and sets the resolution of rendering for a specific region on the screen at a predetermined resolution.

### BACKGROUND

### Field of the Technology

The present disclosure generally relates to a technique for information processing when an image is captured and, more particularly, to an information processing apparatus, method, and storage medium.

### Description of the Related Art

A head mounted display is used as a device for experiencing contents of virtual reality. The virtual reality is referred to below as the “VR”, and the head mounted display is referred to below as the “HMD”. As for the HMD, an image that is generated depending on the position or posture of a user is displayed, and this enables the user to have an experience as if moving through a virtual space.

An image to be displayed on the HMD is typically generated by rendering computer graphics (CG) in a virtual camera view. At this time, processing called foveated rendering is performed to reduce the processing load of rendering. The foveated rendering is referred to below as the “FR”. The FR is a technique for performing a rendering process in consideration for visual resolution characteristics of human eyes such that a central region in a field of view has a high resolution, and a peripheral region has a low resolution. This enables the processing load at the execution of rendering to be reduced such that the user who uses the HMD does not recognize image quality degradation. The FR is classified into fixed foveated rendering and foveated rendering (eye trucked foveated rendering) in which a line of sight is tracked. The fixed foveated rendering is referred to below as the “FFR”, and the foveated rendering in which the line of sight is tracked is referred to below as the “ETFR”. The FFR is FR in which the position of the line of sight is fixed at the center of a screen. The ETFR is FR in which the changing position of the line of sight of the user is tracked, and rendering is performed such that a region containing the changing position of the line of sight has a high resolution, and the other region has a low resolution. The ETFR can reduce the processing load more than the FFR.

A provided screen capture function is to record an image that the user views through the HMD in a file as a still image or a moving image. The function is mainly used for the user to check the image later or to share the image with another person.

Japanese Patent Laid-Open No. 2020-67820 discloses a technique for outputting a high-quality image at the execution of screen capture by performing off screen rendering instead of real-time rendering.

### SUMMARY

According to some embodiments of the present disclosure, there is provided an information processing apparatus including a setting unit that sets a resolution of rendering such that the resolution of rendering differs between a region depending on a line of sight of a user to a screen and another region; a rendering unit that renders an image to be displayed on the screen, depending on the resolution of rendering that is set by the setting unit; and a state determining unit that determines whether capturing of the image that is displayed on the screen is being performed. In a case where the state determining unit determines that the capturing is being performed, the setting unit cancels a setting of the resolution of rendering for the region depending on the line of sight of the user and the other region and sets the resolution of rendering for a specific region on the screen at a predetermined resolution.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of a HMD system that serves as an image display system.

FIG. 2 is an internal configuration diagram of a HMD.

FIG. 3 illustrates a system configuration of an information processing apparatus.

FIG. 4 illustrates a functional configuration of an information processing apparatus according to a first embodiment.

FIG. 5 is a flowchart of information processing according to the first embodiment.

FIGS. 6A to 6C illustrate examples of a resolution map.

FIG. 7 illustrates a functional configuration of an information processing apparatus according to a second embodiment.

FIG. 8 is a flowchart of information processing according to the second embodiment.

FIG. 9 illustrates a functional configuration of an information processing apparatus according to a third embodiment.

FIG. 10 is a flowchart of information processing according to the third embodiment.

FIG. 11 illustrates an example of display of information representing that screen capture is being performed.

FIG. 12 illustrates a functional configuration of an information processing apparatus according to a fourth embodiment.

FIG. 13 is a flowchart of information processing according to the fourth embodiment.

FIG. 14 illustrates a functional configuration of an information processing apparatus according to a fifth embodiment.

FIG. 15 is a flowchart of information processing according to the fifth embodiment.

FIG. 16 is a flowchart of state transition processing.

FIG. 17 illustrates an example of a display image on which check information is superimposed.

FIG. 18 illustrates a functional configuration of an information processing apparatus according to a sixth embodiment.

FIG. 19 is a flowchart of information processing according to the sixth embodiment.

FIGS. 20A and 20B illustrate examples of a display image on which an instruction UI and check information are superimposed.

### DESCRIPTION OF THE EMBODIMENTS

Various exemplary embodiments, features, and aspects according to the present disclosure will hereinafter be described with reference to the drawings. The embodiments described below do not limit the present disclosure, and all combinations of features described according to the embodiments are not necessarily essential for solutions according to the present disclosure. Structures according to the embodiments can be appropriately modified or altered depending on various conditions (such as conditions for use and usage environment) or specifications of devices for which the present disclosure is used. Parts of the embodiments and modifications described later may be appropriately combined. According to the embodiments described below, a duplicated description for the same hardware structure, functional configuration, and processing step is omitted.

In the case where screen capture is performed while a rendering process is performed by ETFR (foveated rendering in which a line of sight is tracked), a region in a saved image has a high resolution, and the other region has a low resolution. In particular, in the case of a moving image, if the line of sight of a user who wears a HMD changes, a high-resolution image region in a captured moving image is viewed so as to move accordingly. In particular, in the case where another person views a captured moving image, the high-resolution image region irregularly moves on a screen, and a low-resolution blurry region irregularly moves simultaneously. Accordingly, the moving image is very difficult to view. Screen capture by using off-screen rendering is not performed in real time and is accordingly unsuitable for a case where it may be desirable to render multiple images per second such as a moving image.

In view of this, the present disclosure is directed to reduce difficulty in image viewing in the case where screen capture is performed.

### First Embodiment

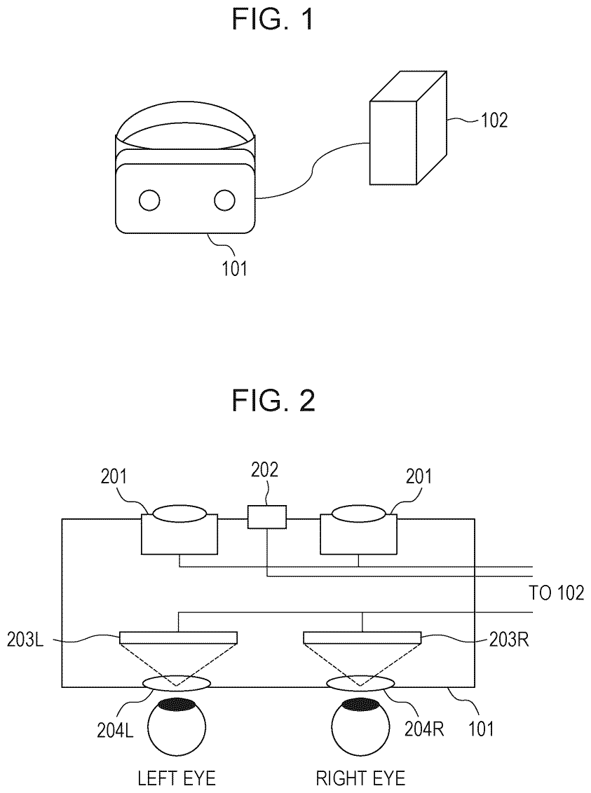

FIG. 1 illustrates an example of a schematic configuration of an image display system according to the present embodiment. In an example described according to the present embodiment, a user experiences contents of virtual reality (VR) by using a head mounted display (HMD) 101. As illustrated in FIG. 1, the image display system includes the HMD 101 and an information processing apparatus 102.

The HMD 101 and the information processing apparatus 102 are connected to each other via a predetermined communication path so as to be capable of transmitting and receiving various kinds of data such as image data and various control signals. In an example in FIG. 1, the HMD 101 and the information processing apparatus 102 are connected to each other by using a cable conforming to a standard such as the High-Definition Multimedia Interface (HDMI) (registered trademark) or Universal Serial Bus (USB). The type of the communication path that connects the HMD 101 and the information processing apparatus 102 to each other is not particularly limited. In a specific example, the communication path between the HMD 101 and the information processing apparatus 102 may be established by wireless communication such as Bluetooth (registered trademark). A system configuration illustrated in FIG. 1 is just an example, and the structure of the image display system according to the present embodiment is not limited to the example in FIG. 1. For example, an input device, not illustrated, such as a controller or a keyboard for receiving an input from the user may be connected to the information processing apparatus 102 with a predetermined communication path interposed therebetween.

FIG. 2 illustrates an example of an internal configuration of the HMD 101. As illustrated in FIG. 2, for example, the HMD 101 includes multiple imaging devices 201, a distance sensor 202, displays 203L and 203R, and eyepieces 204L and 204R. The multiple imaging devices 201 are imaging devices for imaging a real space, and examples thereof include RGB cameras. The distance sensor 202 is a sensor for acquiring depth information representing a distance to an object located in an external environment, and example thereof include a light detection and ranging (LiDAR) device and an imaging device. The display 203L and 203R are components for displaying images, and examples thereof include display panels such as liquid crystal panels and organic electroluminescent (EL) panels. The display 203L is a left-eye display for the left eye of the user who wears the HMD 101, and the display 203R is a right-eye display for the right eye of the user. The eyepiece 204L is a left-eye eyepiece for the left eye of the user who wears the HMD 101, and the eyepiece 204R is a right-eye eyepiece for the right eye of the user. The HMD 101 also includes inertial measurement units (IMUs) such as a gyro-sensor and an accelerometer for position tracking of the HMD 101 and an imaging device although these are not illustrated.

The information processing apparatus 102 generates a left-eye display image that is displayed on the display 203L of the HMD 101 for the left eye, generates a right-eye display image that is displayed on the display 203R for the right eye, and transmits the left-eye display image and the right-eye display image to the HMD 101. The HMD 101 is worn on the head of the user not illustrated, displays the left-eye display image on the display 203L for the left eye, and displays the right-eye display image on the display 203R for the right eye. This enables the user to observe an enlarged virtual image of the left-eye display image that is displayed on the display 203L via the eyepiece 204L and to observe an enlarged virtual image of the right-eye display image that is displayed on the display 203R via the eyepiece 204R.

The information processing apparatus 102 may create parallax between the left-eye display image and the right-eye display image depending on a distance (for example, a distance between the eyepieces 204 for the left and right eyes) between the left and right eyes of the user who wears the HMD 101. Such control enables the user who wears the HMD 101 to experience image perception with a sense of depth.

In the description according to the present embodiment, attention is paid to the system configuration where the information processing apparatus 102 and the HMD 101 are separated. However, the structure of the image display system according to the present embodiment is not limited thereto. For example, the image display system according to the present embodiment may be an integrated HMD system that includes a structure corresponding to the information processing apparatus 102 in the HMD 101.

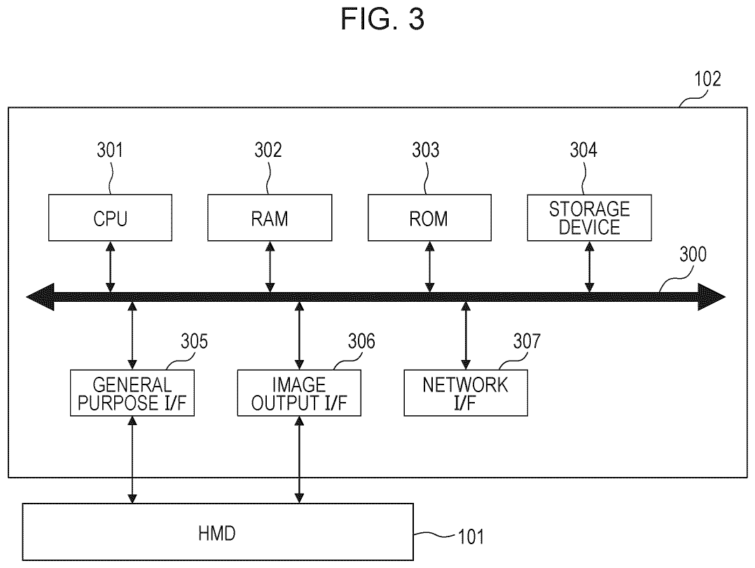

FIG. 3 illustrates an example of a hardware configuration of the image display system according to the present embodiment. In FIG. 3, attention is paid particularly to the hardware configuration of the information processing apparatus 102.

The information processing apparatus 102 includes a central processing unit (CPU) 301, a random access memory (RAM) 302, and a read only memory (ROM) 303. The information processing apparatus 102 also includes a storage device 304, a general purpose interface (I/F) 305, an image output I/F 306, and a network I/F 307. These components of the information processing apparatus 102 are connected to each other with a main bus 300 interposed therebetween so as to be capable of transmitting and receiving information.

The CPU 301 is a processor that collectively controls components in the information processing apparatus 102.

The RAM 302 functions as a work area and a main memory of the CPU 301. The ROM 303 stores control programs that are run by the CPU 301. For example, the storage device 304 stores an operating system (OS), various application programs including an information processing program according to the present embodiment that is run by the CPU 301, and data that is used for image processing. Examples of the storage device 304 include a hard disk drive (HDD) and a solid state drive (SSD). The information processing program according to the present embodiment may be stored in the ROM 303.

The general purpose I/F 305 is a serial bus interface conforming to a standard such as the USB or the IEEE1394 (Institute of Electrical and Electronics Engineers 1394).

For example, the general purpose I/F 305 is connected to the IMUs and the distance sensor that are included in the HMD 101. For example, this enables the information processing apparatus 102 to acquire posture information or a depth image (an image in which depth information depending on a measured distance to an object is mapped for every pixel) from the HMD 101. The general purpose I/F 305 is also used to acquire an image depending on the result of imaging by using the imaging devices 201 of the HMD 101.

The image output I/F 306 is an interface such as a HDMI or display port interface and is used to transmit a display image that is displayed on the displays 203 of the HMD 101 to the HMD 101.

The network I/F 307 is an interface for connecting the information processing apparatus 102 to a predetermined network. The structure of the network I/F 307 may be appropriately changed depending on the type of the connected network or a communication method that is used.

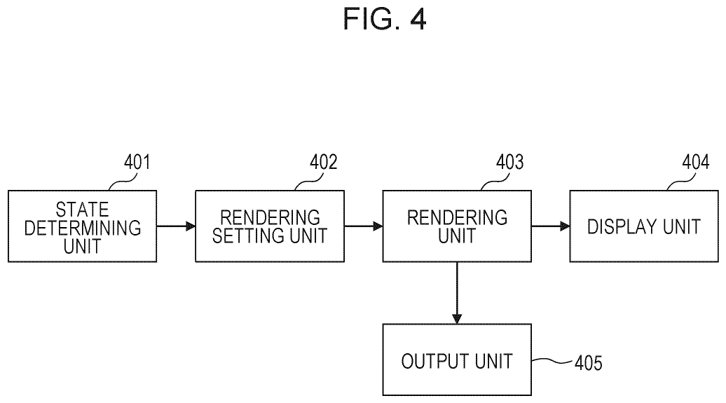

FIG. 4 illustrates a functional configuration of the image display system according to the present embodiment where attention is paid particularly to the structure of the information processing apparatus 102.

The information processing apparatus 102 includes a state determining unit 401, a rendering setting unit 402, a rendering unit 403, a display unit 404, and an output unit 405.

The state determining unit 401 determines whether a screen capture function is being performed.

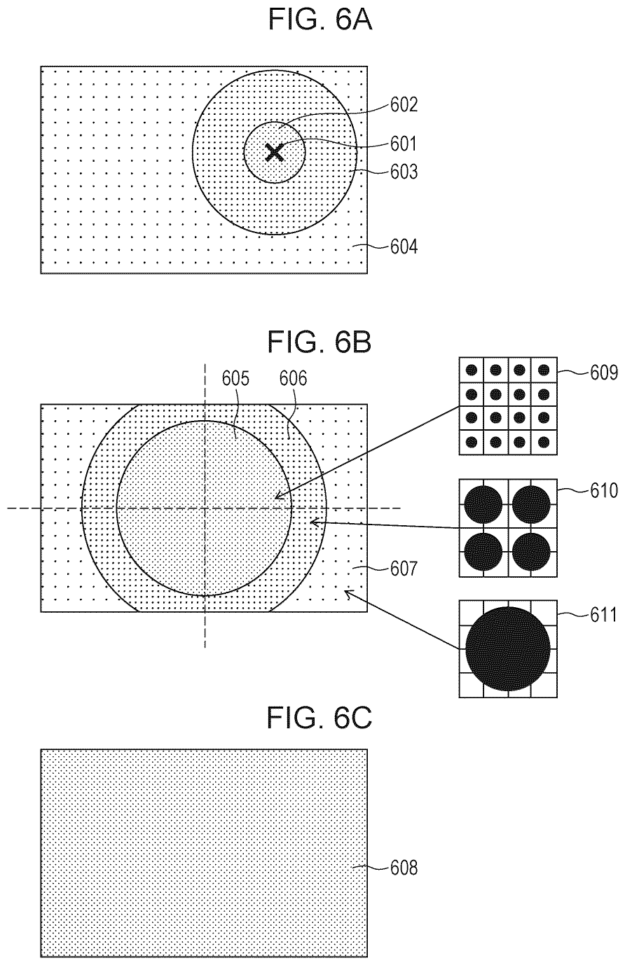

The rendering setting unit 402 configures various settings when a rendering process is performed. For example, the rendering setting unit 402 sets parameters that are used for rendering such as a resolution of rendering, an angle of view, and a positional posture of a virtual camera corresponding to a positional posture of the HMD. In the case where a foveated rendering (FR) process is performed as the rendering process, the rendering setting unit 402 sets information that may be used for the FR process. The FR is classified into fixed foveated rendering (FFR) and foveated rendering in which a line of sight is tracked (ETFR) as described above, and the rendering setting unit 402 is capable of determining whether the FFR or the ETFR is used. The rendering setting unit 402 sets a resolution map that is used in the FR process as map region information representing the resolution of rendering as illustrated in FIGS. 6A to 6C described later.

The rendering unit 403 performs the rendering process, based on rendering settings configured by the rendering setting unit 402 and generates rendered images. According to the present embodiment, the rendering unit 403 generates rendered images for the respective displays 203L and 203R of the HMD 101.

The display unit 404 transmits the rendered images to the HMD 101 via the image output I/F 306 and consequently causes the displays 203L and 203R of the HMD 101 to display the rendered images.

The output unit 405 records the rendered images to a file in the storage device 304.

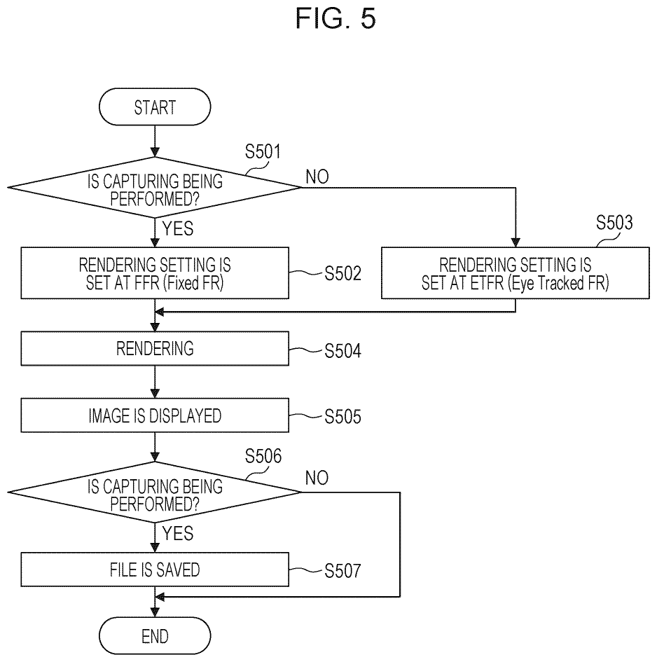

FIG. 5 is a flowchart particularly illustrating the flow of information processing that is performed by the information processing apparatus 102 in the image display system according to the present embodiment. A series of processes in the flowchart illustrated in FIG. 5 are performed in a manner in which the information processing program according to the present embodiment that is stored in the ROM 303 or the storage device 304 in the information processing apparatus 102 is loaded into the RAM 302 and run by the CPU 301. Consequently, the CPU 301 serves as components illustrated in FIG. 4. The processes in the flowchart illustrated in FIG. 5 correspond to a series of processing per frame. Accordingly, the CPU 301 repeats the processes for every frame, consequently enables the user to view a moving image that is displayed on the HMD 101, and enables the storage device 304 to save a screenshot of the moving image to a file. In flowcharts described later including this flowchart, a symbol S represents a processing step.

At S501, the state determining unit 401 first determines whether the information processing apparatus 102 is performing the screen capture function on a moving image or a still image. In the case where the state determining unit 401 determines that the screen capture function is being performed (referred to below as “capturing is being performed”), the processing of the information processing apparatus 102 proceeds to S502. In the case where the state determining unit 401 determines that the screen capture function is not being performed (capturing is not being performed), the processing of the information processing apparatus 102 proceeds to S503.

At S502, the rendering setting unit 402 sets the mode of the rendering process such that the resolution of rendering in a specific region on a display screen of the HMD 101 is a predetermined resolution. According to the present embodiment, the rendering setting unit 402 fixes the specific region at a central region on the screen and sets the mode of the rendering process such that the predetermined resolution of rendering in the central region is higher than that in the other region. More specifically, in the case where the capturing is being performed, the rendering setting unit 402 sets the mode (the mode of the FR) of the rendering process at the mode of the FFR (the fixed foveated rendering). In the mode of the FFR, the central region on the screen is set at a high-resolution region as described above. The rendering setting unit 402 sets a resolution map used to perform rendering in the mode of the FFR.

FIGS. 6A to 6C illustrate examples of a resolution map that may be used for the FR.

In the case of the FFR, the rendering setting unit 402 sets a resolution map illustrated in FIG. 6B.

A map region 605 in FIG. 6B is a region in which rendering is performed at a high resolution and is located at an image center in the case of the FFR. As illustrated in 4×4 partial regions 609 into which an enlarged portion of the map region 605 is divided, the rendering unit 403 makes calculations of rendering with respect to all pixels as illustrated by using black circles in the figure.

A map region 606 in FIG. 6B is a region in which rendering is performed at a lower resolution than in the map region 605. For example, the resolution in the map region 606 is a resolution reduced such that the height and width of the map region 605 are halved. In this case, as illustrated in 4×4 partial regions 610 into which an enlarged portion of the map region 606 is divided, the rendering unit 403 makes a single calculation of rendering for every four pixels of a 2×2 pixel array. That is, in this case, the number of calculations of rendering is reduced to one-fourth. The same result is stored in each pixel of four pixels of the 2×2 pixel array.

A map region 607 in FIG. 6B is a region in which rendering is performed at a lower resolution than in the map region 606. For example, the resolution in the map region 607 is a resolution reduced such that the height and width of the map region 605 are reduced to one-fourth. In this case, as illustrated in 4×4 partial regions 611 into which an enlarged portion of the map region 607 is divided, the rendering unit 403 makes a single calculation of rendering for every 16 pixels of a 4×4 pixel array. That is, in this case, the number of calculations of rendering is reduced to one-sixteenth. The same result is stored in each pixel of 16 pixels of the 4×4 pixel array.

In the case where the rendering unit 403 performs the rendering process, based on the resolution map illustrated in FIG. 6B, a processing load can be reduced unlike the case where an entire image is rendered at a high resolution without the FR. In the case of the FFR, as illustrated in FIG. 6B, the map region 605 in which rendering is performed at a high resolution is fixed at the central region regardless of the position of the line of sight of the user who uses the HMD 101. As for the FFR, it may be desirable for a high-resolution region to be enlarged more than the ETFR. The reason is that unless rendering is performed at a high resolution up to a region to which the line of sight changes due to human eye movement, the user who uses the HMD recognizes a reduction in resolution.

In the case where the capturing is being performed, the rendering unit 403 fixes, at the central region on the screen, a specific region in which rendering is performed at a high resolution and performs the rendering process. That is, in the case where the capturing is being performed, the information processing apparatus 102 according to the present embodiment stops the rendering process in which the position of a high-resolution region on the screen is changed depending on tracking of the line of sight of the user as in the ETFR and performs the rendering process by using the FFR.

At S503, the rendering setting unit 402 sets the mode of the rendering process such that the resolution of rendering in the region depending on the line of sight of the user differs from the resolution of rendering in the other region. According to the present embodiment, the rendering setting unit 402 sets, as the mode of the rendering process such that the resolution of rendering in the region depending on the line of sight of the user differs from the resolution of rendering in the other region, the mode of the ETFR (the foveated rendering in which the line of sight is tracked). That is, the rendering setting unit 402 sets the mode of the rendering process such that rendering is performed at a high resolution at a position depending on tracking of the line of sight of the user, and rendering is performed at a low resolution in the other region. The rendering setting unit 402 sets a resolution map that may be used to perform the rendering process in the mode of the ETFR.

FIG. 6A illustrates an example of the resolution map that is set by the rendering setting unit 402 in the case of the ETFR.

In FIG. 6A, a map region 602 is a region in which rendering is performed at a high resolution, a map region 603 is a region in which rendering is performed at a lower resolution than in the map region 602, and a map region 604 is a region in which rendering is performed at a lower resolution than in the map region 603. The number of calculations of rendering in the map regions 602, 603, and 604 changes depending on the setting of the resolution in the map regions, and this is the same as in the case of the FFR described for S502.

In the case of the ETFR, the center of a high-resolution region is not the image center but is at a position 601 of the line of sight of the user who uses the HMD unlike the FFR. In the resolution map illustrated in the example in FIG. 6A, the position 601 of the line of sight of the user is located at the upper right in an image. In the case of the ETFR, the rendering setting unit 402 tracks the position of the line of sight of the user in real time, sets a resolution map depending on the position of the line of sight, and accordingly uses different resolution maps between frames in practice. In the ETFR, when the line of sight of the user changes due to the eye movement, the resolution maps can be changed depending on the changing line of sight. Accordingly, a region in which rendering is performed at a high resolution can be narrowed more than the FFR.

In the resolution maps illustrated by way of example in the examples in FIGS. 6A and 6B, three different resolutions are illustrated by using circles, but the settings of the resolution maps are not limited to these examples. The rendering setting unit 402 can freely set the size, number, and shape of the map regions. For example, FIG. 6C illustrates an example of a resolution map (a map region 608) for rendering an entire image at a high resolution. That is, the rendering setting unit 402 can set the resolution map illustrated in FIG. 6C as a resolution map for the FFR described for S502. In the case of this example, the same processing as processing when no FR process is performed is performed.

After S502 or S503 described above, the processing of the information processing apparatus 102 proceeds to S504.

At S504, the rendering unit 403 performs the rendering process in the mode of the rendering process that is set by the rendering setting unit 402 such that the resolution differs among the map regions and generates rendered images for the relevant frame. A method of performing the rendering process such that the resolution differs among the regions may be a known method such as a variable rate shading method.

Subsequently, at S505, the display unit 404 transmits the rendered images that are generated by the rendering unit 403 to the HMD 101 via the image output I/F 306 and causes the displays 203 to display the rendered images.

Subsequently, at S506, the state determining unit 401 determines again whether capturing of a moving image or a still image is being performed. In the case where the state determining unit 401 determines that the capturing is being performed, the processing of the information processing apparatus 102 proceeds to S507. In the case where the state determining unit 401 determines that the capturing is not being performed, the information processing apparatus 102 ends the processing in the flowchart in FIG. 5.

At S507, the output unit 405 records the rendered images to a file in the storage device 304. The output unit 405 may synchronously write to the file in processing for each frame or may asynchronously write to the file sequentially while buffering the rendered images in a buffer that is provided in the RAM 302 in the case where writing to the file takes time. The output unit 405 is thus capable of selecting an appropriate method suitable for the data size of the rendered images or the processing capacity of the information processing apparatus.

The information processing apparatus 102 according to the first embodiment performs processing while reducing a rendering load by using the ETFR in a normal case where the screen capture is not performed but sets the FFR in the case where the screen capture is performed as described above. That is, in the case where the screen capture is performed, a high-resolution region can be always fixed at the image center. This reduces difficulty in viewing when the screen capture is performed particularly for a moving image. According to the present embodiment, irregular movement non-independent on the positions of a low-resolution blurry region and a high-resolution region in a moving image captured by the ETFR is eliminated, and a screen-captured moving image can be generated.

### Second Embodiment

According to the first embodiment, a process of setting the FFR in the case where the screen capture is performed is described. In general, it may be desirable for the FFR to enlarge a high-resolution region more than the ETFR as described above. For this reason, the FFR tends to have a higher processing load of rendering than the ETFR and accordingly greatly reduces the frame rate, for example, in the case where computer graphics (CG) to be rendered is complex, and a computational load is high.

In view of this, according to a second embodiment, the rendering angle of view is narrowed such that an increased in the processing load is canceled in addition to a change in setting into the FFR during the screen capture, and consequently, the processing load of rendering is optimized as described later. The structure of the image display system, the structure of the HMD 101, and the hardware configuration according to the second embodiment are the same as those in the examples in FIGS. 1 to 3 described above, and an illustration and description for these are omitted.

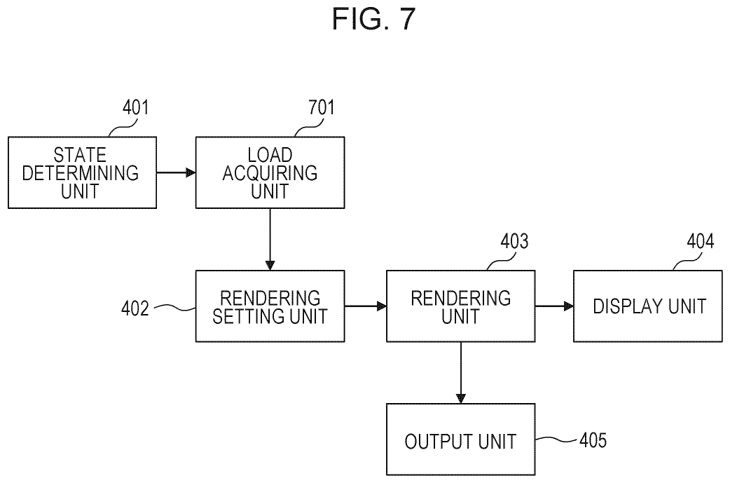

FIG. 7 illustrates a functional configuration of the image display system according to the second embodiment where attention is paid particularly to the structure of the information processing apparatus 102. The information processing apparatus 102 according to the second embodiment includes a load acquiring unit 701 in addition to the structure described according to the first embodiment. The other components other than the load acquiring unit 701 are the same as the components in FIG. 4, and description for these is omitted.

In the case where the state determining unit 401 determines that the capturing is being performed, the load acquiring unit 701 acquires an increase in the processing load of rendering when the setting of the FR is changed from the ETFR into the FFR. The increase in the processing load may be acquired by reading a stored calculation result acquired in advance or may be calculated in real time.

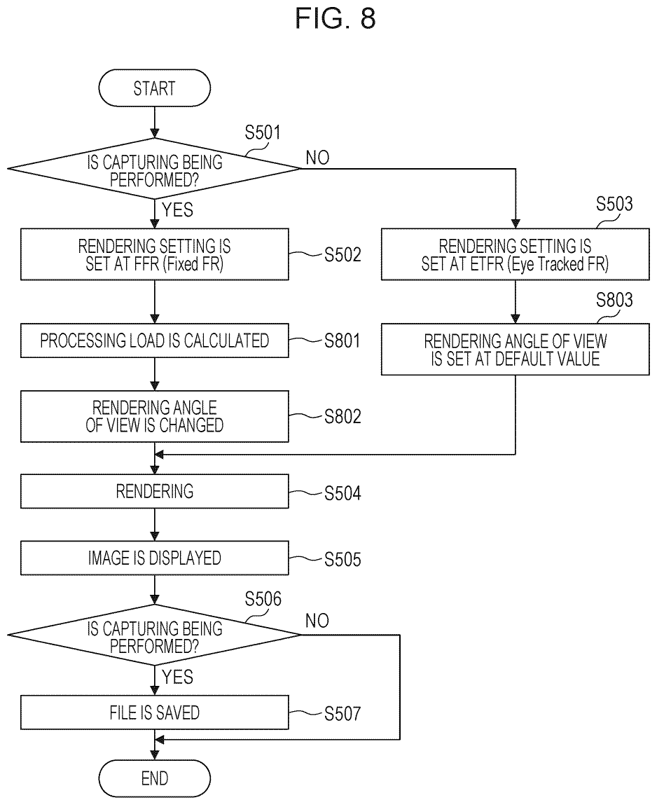

FIG. 8 is a flowchart particularly illustrating the flow of information processing that is performed by the information processing apparatus 102 in the image display system according to the second embodiment. A series of processes in the flowchart illustrated in FIG. 8 are performed in a manner in which an information processing program according to the second embodiment that is stored in the ROM 303 or the storage device 304 is loaded into the RAM 302 and run by the CPU 301. Consequently, the CPU 301 serves as components illustrated in FIG. 7.

The processes in the flowchart illustrated in FIG. 8 correspond to a series of processing per frame. Accordingly, repeating the processes for every frame enables the user to view a moving image that is displayed on the HMD 101 and enables the storage device 304 to save a screenshot of the moving image to a file. In the flowchart illustrated in FIG. 8, processing steps like to those in the flowchart in FIG. 5 described above are designated by reference characters like to those in FIG. 5, and description for these is omitted.

In the case of the flowchart in FIG. 8, after the state determining unit 401 determines at S501 that the capturing is being performed, and the rendering setting unit 402 sets the FFR at S502, the processing of the information processing apparatus 102 proceeds to S801.

At S801, the load acquiring unit 701 calculates the increase in processing load of rendering in the case where the setting of the FR is changed from the ETFR to the FFR. For example, when the number of calculations of rendering in the case of the ETFR is NETFR, and the number of calculations of rendering in the case of the FFR is NFFR, the load acquiring unit 701 calculates a ratio between these as an increase R in the processing load by using expression (1) described below.

$$R = {N}_{FFR} / {N}_{ETER} \qquad Expression ( 1 )$$

The increase R in the processing load may not be calculated for every frame. In the case where the processing load does not change between frames, the increase R in the processing load that is calculated for a previous frame and that is stored may be used. Alternatively, the increase in the processing load that is calculated in advance from, for example, design data of a resolution map and that is stored before rendering is performed may be read. After S801, the processing of the information processing apparatus 102 proceeds to S802.

At S802, the rendering setting unit 402 sets the rendering angle of view such that the increase in the processing load of rendering that is calculated at S801 is canceled. For example, when, regarding default rendering, a horizontal angle of view is θ, and a vertical angle of view is φ, the rendering setting unit 402 calculates a horizontal angle θ′ of view and a vertical angle φ′ of view of the rendering angle of view by using expression (2) and expression (3) described below.

$${θ}^{′} = θ / √ ( R ) \qquad Expression ( 2 )$$

$${φ}^{′} = φ / √ ( R ) \qquad Expression ( 3 )$$

In an example described herein, the horizontal angle of view and the vertical angle of view are changed by the same ratio in order to maintain an aspect ratio. However, a method of setting each angle of view is not limited thereto, but the change ratio between the horizontal angle of view and the vertical angle of view may be freely set. As for the calculation of the angle of view, in the case where the increase R in the processing load does not change between frames, the angle of view that is calculated for a previous frame and that is stored may be used as in the calculation of the increase R in the processing load. After S802, the processing of the information processing apparatus 102 proceeds to S504 described above.

After the state determining unit 401 determines at S501 that the capturing is not being performed, the rendering setting unit 402 sets the ETFR at S503, and so on, the processing of the information processing apparatus 102 proceeds to S803.

At S803, the rendering setting unit 402 sets the rendering angle of view by using the default value of the horizontal angle θ of view and the default value of the vertical angle φ of view. The default value of the angle of view is suitable for the field of view of the HMD 101. After S803, the processing of the information processing apparatus 102 proceeds to S504 described above.

In the case where the rendering angle of view is set at S802 such that the increase in the processing load of rendering is canceled, at S505, the display unit 404 causes the displays 203 to display the rendered images that are generated by the rendering unit 403 depending on the rendering angle of view.

The information processing apparatus 102 according to the second embodiment performs processing while reducing the rendering load by using the ETFR in a normal case as in the first embodiment and sets the FFR only in the case where the screen capture is performed such that a high-resolution region is always fixed at the image center. The information processing apparatus 102 according to the second embodiment narrows the rendering angle of view such that the increase in the processing load in the case where the FFR is set during the capturing is canceled and consequently reduces the processing load of rendering. That is, according to the present embodiment, the difficulty in image viewing due to irregular movement non-independent on the positions of a low-resolution blurry region and a high-resolution region particularly when a moving image is screen-captured is reduced, and the processing load of rendering can be optimized.

### Third Embodiment

In an example described according to the second embodiment, the rendering angle of view is narrowed such that the increase in the processing load is canceled in addition to the change in setting into the FFR during the screen capture, and consequently, the processing load of rendering is optimized. In the case where the rendering angle of view is greatly narrowed, however, there is a concern that the user who uses the HMD 101 is affected so as to be visually and psychologically restricted.

In view of this, according to a third embodiment, a state in which the screen capture is being performed is visually indicated in a region in which a rendered image is not displayed because of the narrowed rendering angle of view, and consequently, visual and psychological influences on the user are reduced. The structure of the image display system, the structure of the HMD 101, and the hardware configuration according to the third embodiment are the same as those in the examples in FIGS. 1 to 3 described above, and an illustration and description for these are omitted.

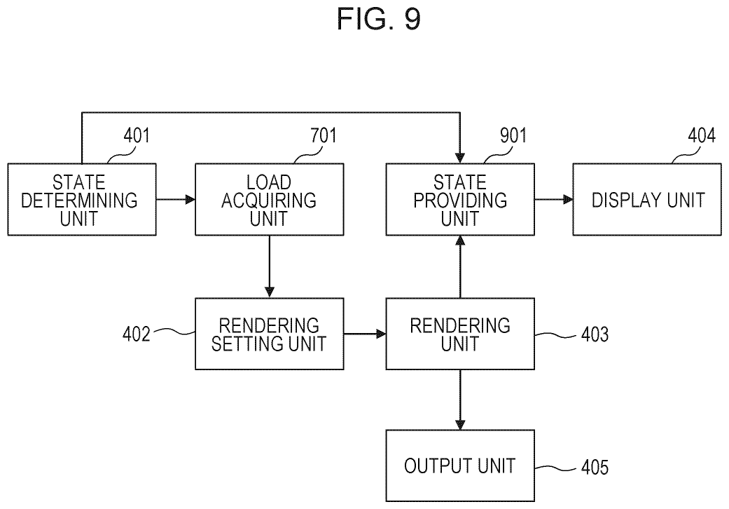

FIG. 9 illustrates a functional configuration of the image display system according to the third embodiment where attention is paid particularly to the structure of the information processing apparatus 102. The information processing apparatus 102 according to the third embodiment includes a state providing unit 901 in addition to the structure described according to the second embodiment. The other components other than the state providing unit 901 are the same as the components in FIG. 7, and description for these is omitted.

In the case where the state determining unit 401 determines that the capturing is being performed, the state providing unit 901 generates a display image to be used so that information representing that the capturing is being performed is superimposed on the rendered images and is displayed by the display unit 404. The display unit 404 causes the displays of the HMD 101 to display the display image such that the information representing that the capturing is being performed is superimposed. This enables the user to recognize that the rendering angle of view is narrowed due to the capturing, and the user is unlikely to be visually and psychologically affected.

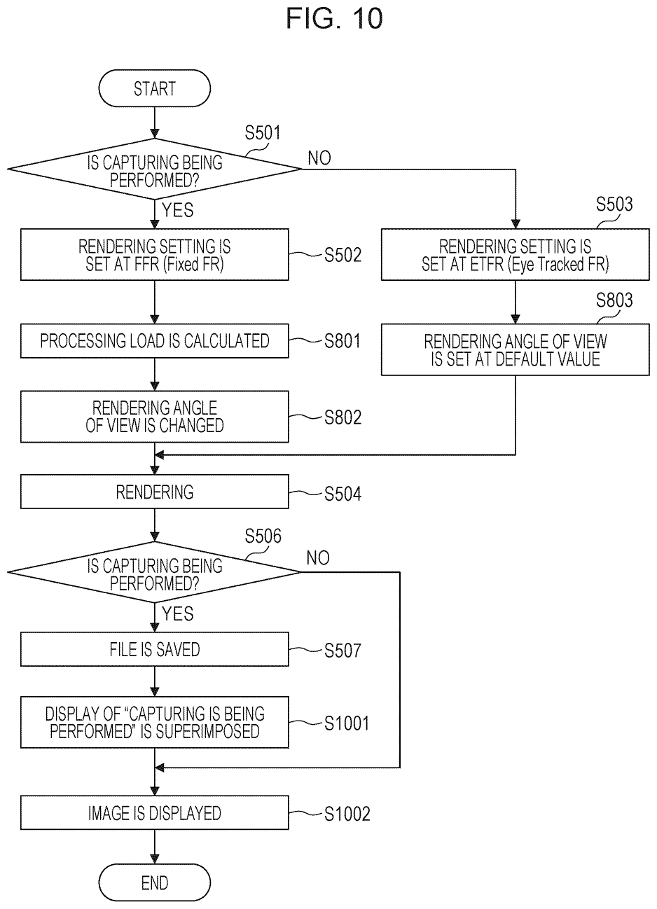

FIG. 10 is a flowchart particularly illustrating the flow of information processing that is performed by the information processing apparatus 102 in the image display system according to the third embodiment. A series of processes in the flowchart illustrated in FIG. 10 are performed in a manner in which an information processing program according to the third embodiment that is stored in the ROM 303 or the storage device 304 is loaded into the RAM 302 and run by the CPU 301. Consequently, the CPU 301 serves as components illustrated in FIG. 9. The processes in the flowchart illustrated in FIG. 10 correspond to a series of processing per frame. Accordingly, repeating the processes for every frame enables the user to view a moving image that is displayed on the HMD 101 and enables the storage device 304 to save a screenshot of the moving image to a file. In the flowchart illustrated in FIG. 10, processing steps like to those in the flowchart in FIGS. 5 and 8 described above are designated by reference characters like to those in FIGS. 5 and 8, and description for these is omitted.

In the case of the flowchart in FIG. 10, after the rendering process is performed by the rendering unit 403 at S504, the processing of the information processing apparatus 102 proceeds to S506.

At S506, the state determining unit 401 determines again whether the capturing is being performed. In the case where the state determining unit 401 determines that the capturing is being performed, the processing of the information processing apparatus 102 proceeds to S507. In the case where the state determining unit 401 determines that the capturing is not being performed, the processing of the information processing apparatus 102 proceeds to S1002.

At S507, the output unit 405 records the rendered images to a file in the storage device 304. The output unit 405 may synchronously write to the file in processing for each frame or may asynchronously write to the file sequentially while buffering the rendered images in the buffer that is provided in the RAM 302 in the case where writing to the file takes time as described above. After S507, the processing of the information processing apparatus 102 proceeds to S1001.

At S1001, the state providing unit 901 generates a display image to be used so that the information representing that the capturing is being performed is superimposed on the rendered images and is displayed by the display unit 404.

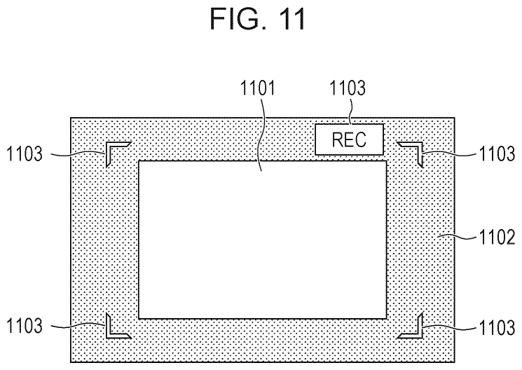

FIG. 11 illustrates an example of a display image that is generated by the state providing unit 901. As illustrated in FIG. 11, the display image has a rendered image display region 1101 and a rendered image non-display region 1102 that is produced by narrowing the rendering angle of view as in the example described according to the second embodiment. For example, in the case where the rendered image non-display region 1102 is displayed in black, the user who uses the HMD 101 can feel a visual sense of pressure. For this reason, according to the present embodiment, the state providing unit 901 generates a display image such that information 1103 representing that the capturing is being performed is superimposed in the rendered image non-display region 1102. This enables the visual sense of pressure of the user to be reduced unlike the case where the rendered image non-display region 1102 is simply displayed in black. FIG. 11 illustrates an example of display including, for example, characters of “REC” representing that recoding is being made and corner marks representing four corners of a frame that surrounds the rendered image display region 1101, which is an example of the information 1103 representing that the capturing is being performed. The example of display of the information representing that the capturing is being performed is not a limitation. After S1001, the processing of the information processing apparatus 102 proceeds to S1002.

At S1002, the display unit 404 causes the displays 203 to display the display image illustrated in FIG. 11, for example, in the case where the rendering angle of view is changed at S802. Subsequently, the information processing apparatus 102 ends the processing in the flowchart in FIG. 10.

The information processing apparatus 102 according to the third embodiment displays the information representing that the capturing is being performed and can consequently reduce a visual or psychological sense of pressure due to the narrowed rendering angle of view. That is, according to the present embodiment, the difficulty in image viewing when a moving image is screen-captured is reduced, the processing load of rendering can be optimized, and the visual or psychological sense of pressure of the user can be reduced.

### Fourth Embodiment

In the example described according to the second embodiment, the rendering angle of view is narrowed in order to reduce the processing load. In the case where a still image is screen-captured instead of a moving image, a generated image has a single frame, and accordingly, a temporary increase in the processing load of the rendering process is small. That is, in the case where a still image is screen-captured, the process of narrowing the rendering angle of view described according to the second embodiment may not be performed.

In view of this, in an example described according to a fourth embodiment, processing is changed depending on whether the mode of the screen capture is a still image capturing mode or a moving image capturing mode.

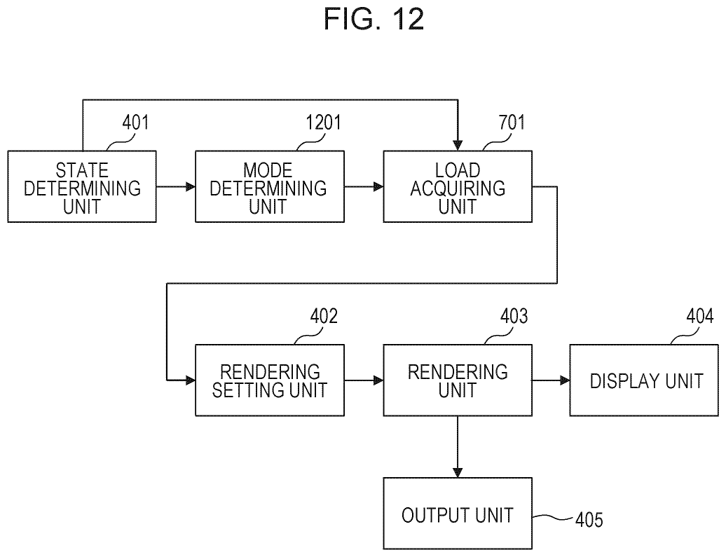

FIG. 12 illustrates a functional configuration of the image display system according to the fourth embodiment where attention is paid particularly to the structure of the information processing apparatus 102. The information processing apparatus 102 according to the fourth embodiment includes a mode determining unit 1201 in addition to the structure described according to the second embodiment.

The other components other than the mode determining unit 1201 are the same as the components in FIG. 7, and description for these is omitted.

In the case where the state determining unit 401 determines that the capturing is being performed, the mode determining unit 1201 determines whether the mode of the screen capture that is being performed is the still image capturing mode or the moving image capturing mode. The mode determining unit 1201 notifies the load acquiring unit 701 of the result of determination of the capturing mode.

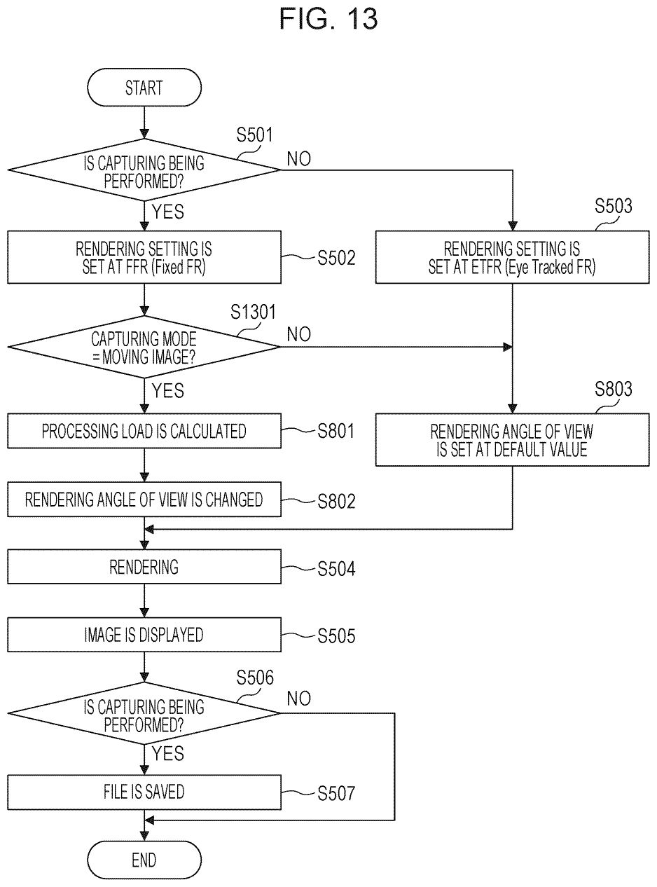

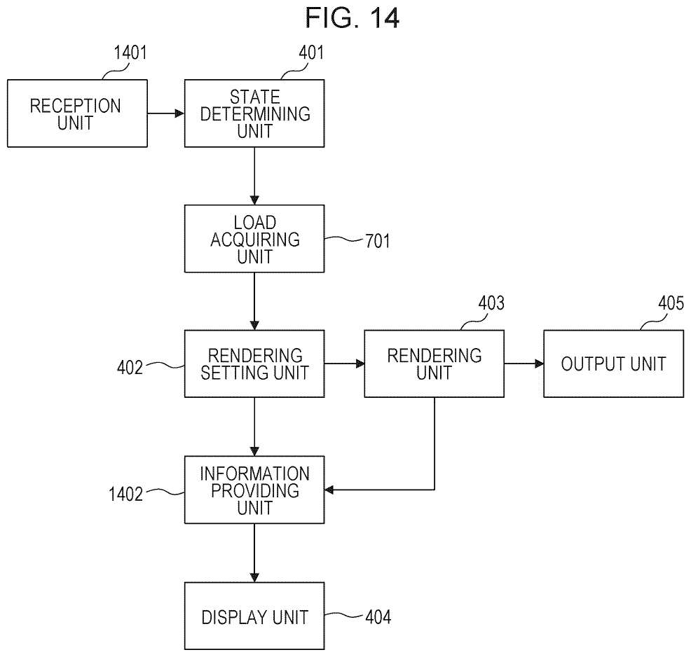

FIG. 13 is a flowchart particularly illustrating the flow of information processing that is performed by the information processing apparatus 102 in the image display system according to the fourth embodiment. A series of processes in the flowchart illustrated in FIG. 14 are performed in a manner in which an information processing program according to the fourth embodiment that is stored in the ROM 303 or the storage device 304 is loaded into the RAM 302 and run by the CPU 301. Consequently, the CPU 301 serves as components illustrated in FIG. 12. The processes in the flowchart illustrated in FIG. 13 correspond to a series of processing per frame. Accordingly, repeating the processes for every frame enables the user to view a moving image that is displayed on the HMD 101 and enables the storage device 304 to save a screenshot of the moving image to a file. Also in the case where a still image is screen-captured, the user can view the screen-captured still image that is displayed on the HMD 101, and the screen-captured still image can be saved to a file in the storage device 304. In the flowchart illustrated in FIG. 13, processing steps like to those in the flowchart in FIG. 8 described above are designated by reference characters like to those in FIG. 8, and description for these is omitted.

In the case of the flowchart in FIG. 13, after the state determining unit 401 determines at S501 that the capturing is being performed, and the rendering setting unit 402 sets the FFR at S502, the processing of the information processing apparatus 102 proceeds to S1301.

At S1301, the mode determining unit 1201 determines whether the mode of the screen capture is the moving image capturing mode. In the case where the mode determining unit 1201 determines that the mode of the screen capture is the moving image capturing mode, the processing of the information processing apparatus 102 proceeds to S801. After S801, the information processing apparatus 102 performs a process of changing the rendering angle of view depending on the increase in the processing load as described according to the second embodiment.

In the case where the mode determining unit 1201 determines at S1301 that the mode of the screen capture is not the moving image capturing mode, that is, in the case where the mode determining unit 1201 determines that the mode of the screen capture is the still image capturing mode, the processing of the information processing apparatus 102 proceeds to S803. Consequently, in the case of the still image capturing mode, the rendering setting unit 402 sets the rendering angle of view at the default value of the angle of view. That is, in the case of the still image capturing mode, the rendering setting unit 402 does not change the rendering angle of view depending on the increase in the processing load. After S803, the processing of the information processing apparatus 102 proceeds to S504 described above.

The information processing apparatus 102 according to the fourth embodiment performs the process of changing the rendering angle of view depending on the increase in the processing load as described according to the second embodiment in the case of the moving image capturing mode and sets the default value of the rendering angle of view in the case of the still image capturing mode. That is, according to the present embodiment, the process of narrowing the rendering angle of view as described according to the second embodiment is not performed in the case of the still image capturing mode, and accordingly, an image that has a wider angle of view than that in the case of the moving image capturing mode can be saved to a file.

Also according to the fourth embodiment, the information representing that the capturing is being performed may be superimposed as described according to the third embodiment in the case of the moving image capturing mode.

### Fifth Embodiment

In the example described according to the second embodiment, in the case where the setting of the FFR is changed during the screen capture, the rendering angle of view is narrowed such that the increase in the processing load is canceled, and the processing load of the rendering is optimized. As a result, the rendering angle of view and the position and size of a high-resolution region in the FR differ between before the screen capture is performed and while the screen capture is being performed. In the case where the user cannot know the rendering angle of view and a high-resolution region at the execution of the screen capture in advance, a displayed image can give the user a sense of discomfort.

In view of this, in an example described according to a fifth embodiment, check information that enables the user to check the rendering angle of view and the high-resolution region at the execution of the screen capture before the screen capture starts is displayed in the case where a screen capture instruction is given from the user.

FIG. 14 illustrates a functional configuration of the image display system according to the fifth embodiment where attention is paid particularly to the structure of the information processing apparatus 102. The information processing apparatus 102 according to the fifth embodiment includes a reception unit 1401 and an information providing unit 1402 in addition to the structure described according to the second embodiment. The other components other than the reception unit 1401 and the information providing unit 1402 are the same as the components in FIG. 7, and description for these is omitted.

The reception unit 1401 receives a start instruction or an end instruction for the screen capture and an end instruction for checking from the user. User instruction information that is received by the reception unit 1401 is transmitted to the state determining unit 401. Accordingly, according to the fifth embodiment, the state determining unit 401 determines that the capturing is being performed, for example, in the case where information about the start instruction for the screen capture is inputted from the reception unit 1401.

The information providing unit 1402 generates a display image to be used so that information representing a high-resolution region at the execution of the screen capture is superimposed on the rendered images and is displayed by the display unit 404.

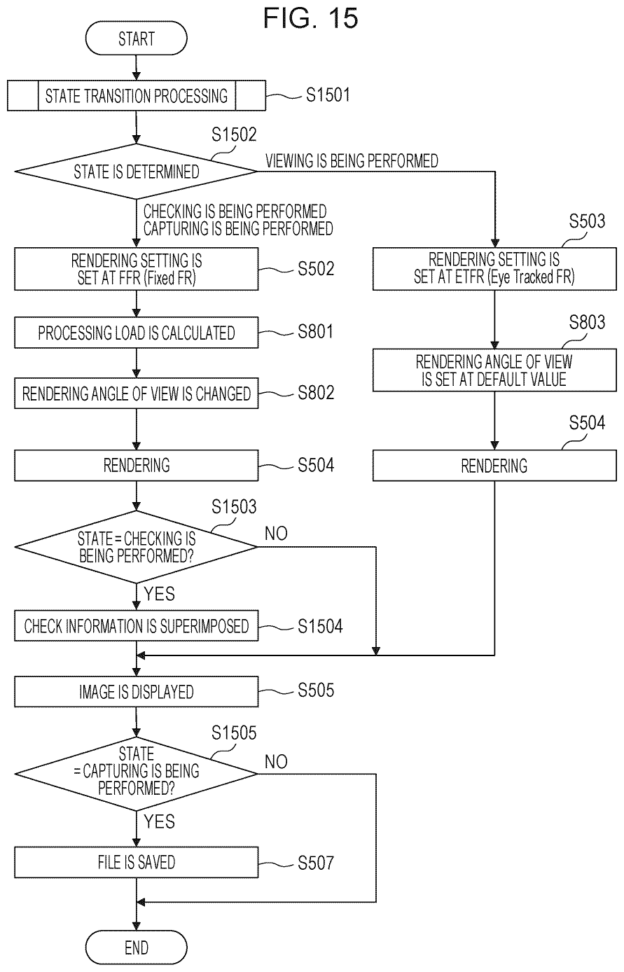

FIG. 15 is a flowchart particularly illustrating the flow of information processing that is performed by the information processing apparatus 102 in the image display system according to the fifth embodiment. A series of processes in the flowchart illustrated in FIG. 15 are performed in a manner in which an information processing program according to the fifth embodiment that is stored in the ROM 303 or the storage device 304 is loaded into the RAM 302 and run by the CPU 301. Consequently, the CPU 301 serves as components illustrated in FIG. 14. The processes in the flowchart illustrated in FIG. 15 correspond to a series of processing per frame. Accordingly, repeating the processes for every frame enables the user to view a moving image that is displayed on the HMD 101 and enables the storage device 304 to save a screenshot of the moving image to a file. In the flowchart illustrated in FIG. 15, processing steps like to those in the flowchart in FIG. 8 described above are designated by reference characters like to those in FIG. 8, and description for these is omitted.

In the case of the flowchart in FIG. 15, the processing of the information processing apparatus 102 first proceeds to S1501.

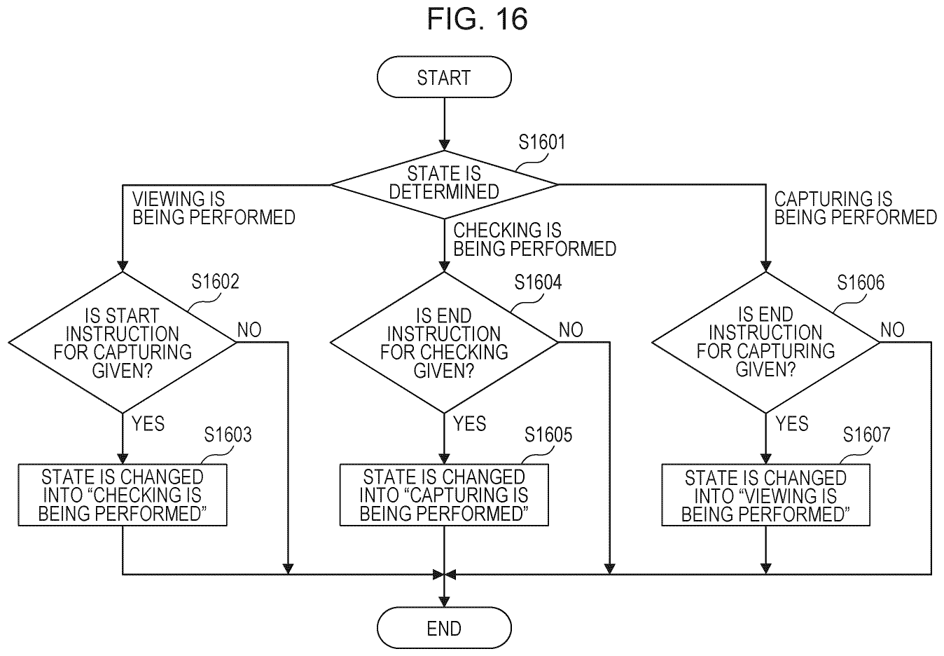

At S1501, the state determining unit 401 changes the state of the information processing apparatus as needed, based on the current state of the information processing apparatus and an instruction from the user. According to the present embodiment, the state of the information processing apparatus is classified into a state in which the user views the rendered images, a state in which the user checks an image to be screen-captured, and a state in which the capturing is being performed. A state in which the user views the rendered images is referred to below as “viewing is being performed”, and a state in which the user checks an image to be screen-captured is referred to below as “checking is being performed”. The detail of state transition processing at S1501 will be described later with reference to FIG. 16.

Subsequently, at S1502, the state determining unit 401 determines whether the current state of the information processing apparatus is a state in which the viewing is being performed, the checking is being performed, or the capturing is being performed. In the case where the state determining unit 401 determines that the current state of the information processing apparatus is a state in which the checking is being performed or the capturing is being performed, the processing of the information processing apparatus 102 proceeds to S502. According to the fifth embodiment, after S502, S801, S802, and S504, the processing of the information processing apparatus 102 proceeds to S1503. In the case where the state determining unit 401 determines that the current state of the information processing apparatus is a state in which the viewing is being performed, the processing of the information processing apparatus 102 proceeds to S503. According to the fifth embodiment, after S503, S803, and S504, the processing of the information processing apparatus 102 proceeds to S505.

At S1503, the state determining unit 401 determines whether the current state of the information processing apparatus is a state in which the checking is being performed. In the case where the state determining unit 401 determines that the current state of the information processing apparatus is a state in which the checking is being performed, the processing of the information processing apparatus 102 proceeds to S1504. In the case where the state determining unit 401 determines that the current state of the information processing apparatus is not a state in which the checking is being performed, the processing of the information processing apparatus 102 proceeds to S505.

At S1504, the information providing unit 1402 generates a display image to be used so that information representing a high-resolution region at the execution of the screen capture is superimposed on the rendered images and is displayed by the display unit 404. After S1504, the processing of the information processing apparatus 102 proceeds to S505.

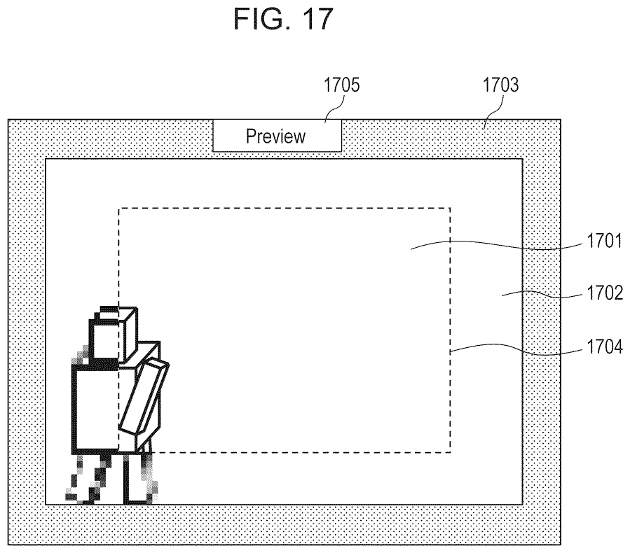

FIG. 17 illustrates an example of the display image that is generated by the information providing unit 1402. As illustrated in FIG. 17, the display image has a high-resolution region 1701, a low-resolution region 1702, and a rendered image non-display region 1703. The high-resolution region 1701 is an image region that is rendered at a high resolution, and the low-resolution region 1702 is an image region that is rendered at a low resolution less than the high resolution. The rendered image non-display region 1703 is the same as the region described according to the third embodiment.

At S1504, the information providing unit 1402 superimposes information representing the boundary between the high-resolution region 1701 and the low-resolution region 1702. This enables the user to easily recognize the high-resolution region. The information representing the boundary between the high-resolution region 1701 and the low-resolution region 1702 is superimposed, for example, by using a rectangular dotted frame 1704. A method of displaying the information representing the boundary is not limited to this example. For example, a solid or circular frame may be used, or the high-resolution region 1701 may be emphatically displayed by reducing the luminance of the low-resolution region 1702 to less than the luminance of the high-resolution region 1701. In order to indicate that the current state of the information processing apparatus is a state in which a check screen for checking the high-resolution region at the execution of the screen capture is displayed, information 1705 representing that the checking is being performed, for example, may be simultaneously displayed. FIG. 17 illustrates an example of display of characters “Preview” representing that the checking is being performed, which is an example of the information 1705 representing that the checking is being performed. After S1504, the processing of the information processing apparatus 102 proceeds to S505.

According to the fifth embodiment, after S505, the processing of the information processing apparatus 102 proceeds to S1505.

At S1505 the state determining unit 401 determines that the current state of the information processing apparatus is a state in which the capturing is being performed. In the case where the state determining unit 401 determines that the capturing is being performed, the processing of the information processing apparatus 102 proceeds to S507. In the case where the state determining unit 401 determines that the current state of the information processing apparatus is not a state in which the capturing is being performed, or after a file is saved at S507, the information processing apparatus 102 ends processing in the flowchart in FIG. 15.

FIG. 16 is a flowchart of the state transition processing that is performed by the state determining unit 401 at S1501.

At S1601, the state determining unit 401 determines that the current state of the information processing apparatus is a state in which the viewing is being performed, the checking is being performed, or the capturing is being performed. In the case where the state determining unit 401 determines that the viewing is being performed, the processing of the information processing apparatus 102 proceeds to S1602. In the case where the state determining unit 401 determines that the checking is being performed, the processing of the information processing apparatus 102 proceeds to S1604. In the case where the state determining unit 401 determines that the capturing is being performed, the processing of the information processing apparatus 102 proceeds to S1606.

At S1602, the reception unit 1401 determines whether the start instruction for the screen capture is given from the user. In the case where the reception unit 1401 determines that the start instruction for the screen capture is given, the processing of the information processing apparatus 102 proceeds to S1603. In the case where the reception unit 1401 determines that the start instruction for the screen capture is not given, the information processing apparatus 102 ends the state transition processing in FIG. 16.

At S1603, the state determining unit 401 changes the current state of the information processing apparatus into a state in which the checking is being performed. After S1603, the information processing apparatus 102 ends the state transition processing in FIG. 16.

At S1604, the state determining unit 401 determines whether the reception unit 1401 receives the end instruction for the checking from the user. In the case where the state determining unit 401 determines that the reception unit 1401 receives the end instruction for the checking, the processing of the information processing apparatus 102 proceeds to S1605. In the case where the state determining unit 401 determines that the end instruction for the checking is not received, the information processing apparatus 102 ends the state transition processing in FIG. 16.

At S1605, the state determining unit 401 changes the current state of the information processing apparatus into a state in which the capturing is being performed. After S1605, the information processing apparatus 102 ends the state transition processing in FIG. 16.

At S1606, the state determining unit 401 determines whether the reception unit 1401 receives the end instruction for the screen capture from the user. In the case where the state determining unit 401 determines that the reception unit 1401 receives the end instruction for the screen capture, the processing of the information processing apparatus 102 proceeds to S1607. In the case where the state determining unit 401 determines that the end instruction for the screen capture is not received, the information processing apparatus 102 ends the state transition processing in FIG. 16.

At S1607, the state determining unit 401 changes the current state of the information processing apparatus into a state in which the viewing is being performed. After S1607, the information processing apparatus 102 ends the state transition processing in FIG. 16.

According to the fifth embodiment, the user can check the high-resolution region and the rendering angle of view at the execution of the screen capture before the screen capture is performed. This enables the user to give the start instruction for the screen capture before the screen capture is performed and after an object to be imaged moves to a position at which the image can be saved at a high resolution.

### Sixth Embodiment

In an example described according to the fifth embodiment, the user can check the high-resolution region and the rendering angle of view at the execution of the screen capture before the screen capture is performed. In the case where the rendering angle of view or the size of the high-resolution region that is checked is not satisfied, it is thought that the user wishes to change the setting thereof.

In view of this, in an example described according to a sixth embodiment, the user can collectively change the rendering settings that are used during the screen capture while the checking is being performed. In a display method described according to the sixth embodiment, the user can collectively check how the rendering angle of view or a high-resolution region changes when the rendering settings are changed in addition to a change in the rendering settings by the user.

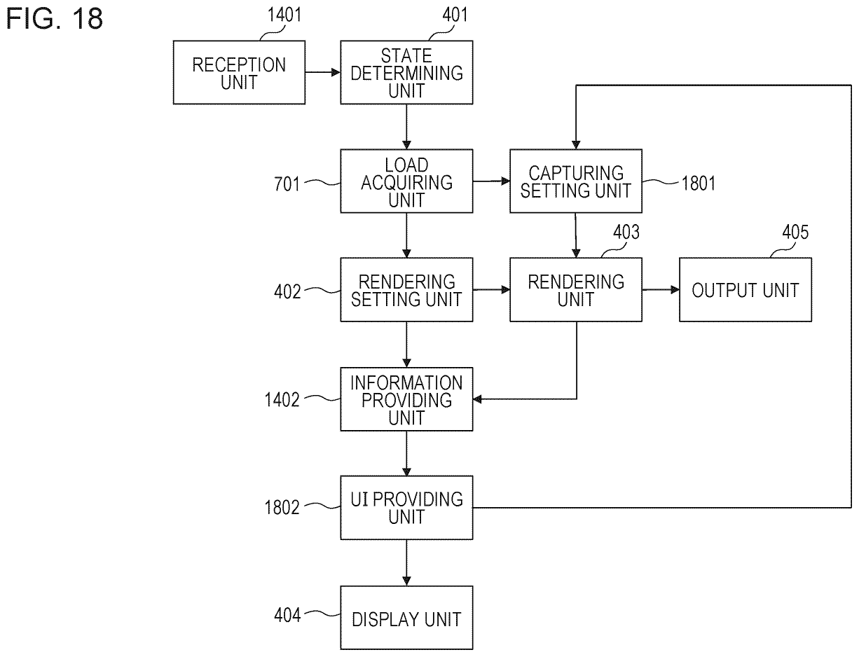

FIG. 18 illustrates a functional configuration of the image display system according to the sixth embodiment where attention is paid particularly to the structure of the information processing apparatus 102. The information processing apparatus 102 according to the sixth embodiment includes a capturing setting unit 1801 and a UI providing unit 1802 in addition to the structure described according to the fifth embodiment. The other components other than the capturing setting unit 1801 and the UI providing unit 1802 are the same as the components in FIG. 14, and description for these is omitted.

The capturing setting unit 1801 changes a rendering setting at the execution of the screen capture, based on an instruction from the user.

The UI providing unit 1802 generates a display image to be used so that a user interface (UI) for a user instruction for changing the rendering setting at the execution of the capturing or for starting the screen capture is superimposed and is displayed by the display unit 404.

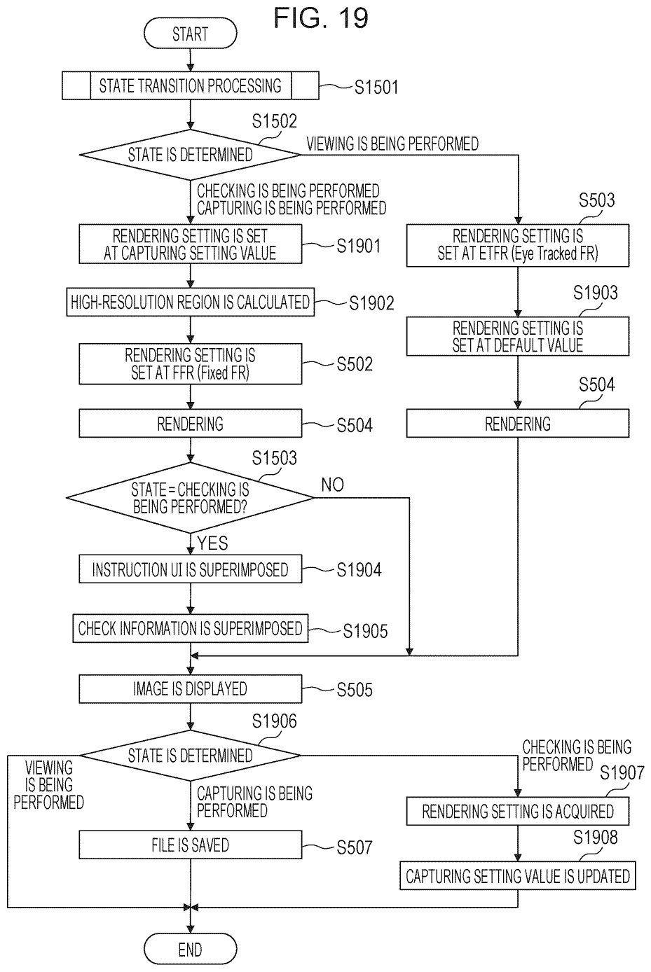

FIG. 19 is a flowchart particularly illustrating the flow of information processing that is performed by the information processing apparatus 102 in the image display system according to the sixth embodiment. A series of processes in the flowchart illustrated in FIG. 19 are performed in a manner in which an information processing program according to the sixth embodiment that is stored in the ROM 303 or the storage device 304 is loaded into the RAM 302 and run by the CPU 301. Consequently, the CPU 301 serves as components illustrated in FIG. 18. The processes in the flowchart illustrated in FIG. 19 correspond to a series of processing per frame.

Accordingly, repeating the processes for every frame enables the user to view a moving image that is displayed on the HMD 101 and enables the storage device 304 to save a screenshot of the moving image to a file. In the flowchart illustrated in FIG. 19, processing steps like to those in the flowchart in FIG. 15 described above are designated by reference characters like to those in FIG. 15, and description for these is omitted.

According to the sixth embodiment, in the case where the state determining unit 401 determines at S1502 that the current state of the information processing apparatus is a state in which the checking is being performed or the capturing is being performed, the processing of the information processing apparatus 102 proceeds to S1901.

At S1901, the capturing setting unit 1801 changes the rendering settings into settings for the screen capture. According to the sixth embodiment, the rendering settings include the frame rate and the rendering angle of view. The rendering settings are not limited thereto. As for the settings for the screen capture, for example, the frame rate is suitable for the refresh rate of a display panel of the HMD 101, and the rendering angle of view is suitable for the field of view of the HMD 101 by default. The settings for the screen capture can be changed in response to an instruction from the user. A user instruction method will be described later together with S1905.

Subsequently, at S1902, the capturing setting unit 1801 calculates a high-resolution region in a resolution map used for the processing of the FFR, based on the rendering settings for the screen capture set at S1901. The size of the high-resolution region is determined based on the increase in the processing load acquired depending on the rendering settings. For example, the default value of the frame rate is f, the number of rendering horizontal pixels is w, the number of rendering vertical pixels is h, the number of horizontal pixels in the high-resolution region in the resolution map is wFFR, the number of vertical pixels in the high-resolution region in the resolution map is hFFR, and a resolution reduction ratio in the in the FFR is RFR. At this time, the number Nf of calculations of rendering can be calculated by using expression (4) described below.

$${N}_{f} = {W}_{FFR} \times {h}_{FFR} + ( w \times h - {w}_{FFR} \times {h}_{FFR} ) \times {R}_{FR} \qquad Expression ( 4 )$$

In the case where the frame rate f is changed into f′, the ratio R_{f} of the frame rate can be calculated by using expression (5) described below.

$${R}_{f} = {f}^{′} / f \qquad Expression ( 5 )$$

When the frame rate f is changed into f′, the number of the horizontal pixels in the high-resolution region in the resolution map is w′_{FFR}, and the number of the vertical pixels in the high-resolution region in the resolution map is

$${h}_{FFR}^{′} .$$

At this time, the number

$${N}_{f}^{′}$$

of calculations of rendering can be calculated by using expression (6) described below.

$${N}_{f}^{′} = \{ {w}_{FFR}^{′} \times {h}_{FFR}^{′} + ( w \times h - {w}_{FFR}^{′} \times {h}_{FFR}^{′} ) \times {R}_{FR} \} \times {R}_{f} \qquad Expression ( 6 )$$

Upon using these, the number of pixels in the high-resolution region that does not cause a change in the number of calculations of rendering even when the frame rate is changed into f′ can be calculated by using expression (7) and expression (8) described below.

$${N}_{f} = {N}_{f}^{′} \qquad Expression ( 7 )$$

$${w}_{FFR}^{′} \times {h}_{FFR}^{′} = \{ {R}_{FR} \times ( 1 - {R}_{f} ) \times w \times h + ( 1 - {R}_{FR} ) \times {w}_{FFR} \times {h}_{FFR} \} / {R}_{f} \times ( 1 - {R}_{FR} ) \} \qquad Expression ( 8 )$$

If the aspect ratio of the high-resolution region is maintained, then the number of pixels in the high-resolution region can be calculated by using expression (9) to expression (11) described below.

$${w}_{FFR} : {h}_{FFR} = {w}_{FFR}^{′} : {h}_{FFR}^{′} \qquad Expression ( 9 )$$

$${w}_{FFR}^{′} = √ [ \{ ( {R}_{FR} \times ( 1 - {R}_{f} ) \times w \times h + ( 1 - {R}_{FR} ) \times {W}_{FFR} \times {h}_{FFR} ) / ( {R}_{f} \times ( 1 - {R}_{FR} ) ) \} \times \{ {w}_{FFR} / {h}_{FFR} \} ] \qquad Expression ( 10 )$$

$${h}_{FFR}^{′} = √ [ \{ ( {R}_{FR} ( 1 - {R}_{f} ) \times w \times h + ( 1 - {R}_{FR} ) \times {W}_{FFR} \times {h}_{FFR} ) / ( {R}_{f} \times ( 1 ‐ {R}_{FR} ) ) \} \times \{ {h}_{FFR} / {w}_{FFR} \} ] \qquad Expression ( 11 )$$

In an example described herein, the aspect ratio is maintained. However, a method of setting the high-resolution region is not limited thereto, and the ratio between the number of the horizontal pixels and the number of the vertical pixels may be freely set. A resolution map for every setting is produced in advance by using the size of the high-resolution region that is acquired as described above, and the capturing setting unit 1801 appropriately configures the setting thereof. After S1902, the processing of the information processing apparatus 102 proceeds to S502.

According to the sixth embodiment, after S503, the processing of the information processing apparatus 102 proceeds to S1903.

At S1903, the rendering setting unit 402 changes the rendering settings into default settings. As for the default settings, for example, the frame rate is suitable for the refresh rate of the display panel of the HMD, the rendering angle of view is suitable for the field of view of the HMD, and the resolution map of the ETFR is based on the position of the line of sight. After S1903, the processing of the information processing apparatus 102 proceeds to S504.

According to the sixth embodiment, in the case where the state determining unit 401 determines at S1503 that the current state of the information processing apparatus is a state in which the checking is being performed, the processing of the information processing apparatus 102 proceeds to S1904.

At S1904, the UI providing unit 1802 superimposes an instruction UI for a user to change a rendering setting at the execution of the capturing or to start the screen capture on the rendered images.

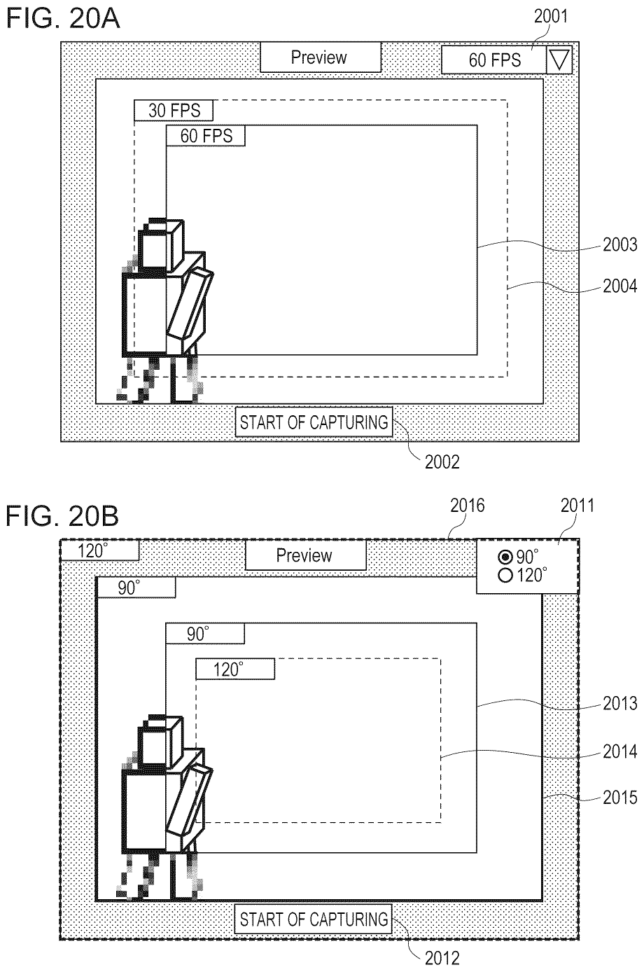

FIGS. 20A and 20B illustrate examples of a rendered image on which a UI is superimposed by the UI providing unit 1802.

FIG. 20A illustrates an example of a rendered image on which a UI for changing the frame rate is superimposed. For example, a UI for an instruction for changing a setting can be a pull-down menu 2001 by which a setting value is selected from multiple predetermined setting values. For example, as for an option for the setting value of the frame rate, the refresh rate of the display panel of the HMD 101 is used as a reference, and an integer of ½, ⅓, . . . thereof is used. A value selected by using the UI is used for a rendering setting at S1901 and is used for rendering. The pull-down menu 2001 is an example and is not a limitation. For example, a radio button may be used. A variable rendering setting is not limited to the frame rate, but the rendering angle of view may be variable.

FIG. 20B illustrates an example in which an UI for an instruction for changing the setting of the rendering angle of view is a radio button 2011. For example, an option for the setting value of the rendering angle of view is an appropriate integer, and the maximum thereof is the field of view of the HMD 101. The UI providing unit 1802 may superimpose a button UI for an instruction for starting the screen capture such as a button 2002 in FIG. 20A or a button 2012 in FIG. 20B.

Subsequently, at S1905, the information providing unit 1402 generates a display image to be used so that information representing the rendering angle of view or the high-resolution region at the execution of the screen capture is superimposed on an image that is generated at S1904 and is displayed by the display unit 404. According to the present embodiment, a rendering setting among several options can be changed based on a user instruction as described for S1904. According to the present embodiment, the information providing unit 1402 displays a high-resolution region for every option in order to indicate how the high-resolution region for every option changes.

FIG. 20A illustrates an example of a display image when the frame rate can be changed. In this example, the frame rate can be selected from two values of 30 FPS (frame/second) and 60 FPS, and the current value is 60 FPS. In the case of the example, a high-resolution region when the setting value is currently 60 FPS is illustrated by using a solid rectangle 2003, and a high-resolution region when the setting value is 30 FPS that can be selected is illustrated by using a dotted rectangle 2004. As another example, FIG. 20B illustrates an example of a display image when the rendering angle of view can be changed. In this example, the rendering angle of view can be selected from two values of 90° and 120°, and 90° is currently selected. At this time, a high-resolution region when the setting value is currently 90° is illustrated by using a solid rectangle 2013, and a high-resolution region when the setting value is 120° that can be selected is illustrated by using a dotted rectangle 2014. As information representing the rendering angle of view, the current rendering angle of view is illustrated by using a thick solid rectangle 2015, and a rendering angle of view of 120° that can be selected is illustrated by using a thick dotted rectangle 2016. After S 1905, the processing of the information processing apparatus 102 proceeds to S505 and subsequently proceeds to S1906.

At 1906, the state determining unit 401 determines whether the current state of the information processing apparatus is a state in which the viewing is being performed, the capturing is being performed, or the checking is being performed. In the case where the state determining unit 401 determines that the capturing is being performed, the processing of the information processing apparatus 102 proceeds to S507. In the case where the state determining unit 401 determines that the checking is being performed, the processing of the information processing apparatus 102 proceeds to S1907. In the case where the state determining unit 401 determines that the viewing is being performed, the information processing apparatus 102 ends processing in the flowchart in FIG. 19.

At S1907, the capturing setting unit 1801 acquires the rendering setting that is set by the user through the instruction UI superimposed at S1904.

Subsequently, at S1908, the capturing setting unit 1801 updates the settings for the screen capture that are used at S1901 by using the rendering setting acquired at S1907. After S1908, the information processing apparatus 102 ends the processing in the flowchart in FIG. 19.

The information processing apparatus 102 according to the sixth embodiment enables the user to change the rendering settings that are used at the execution of the screen capture while the checking is being performed. This enables the user to change the rendering settings in the case where the size of the high-resolution region or the rendering angle of view checked on the check screen is not satisfied.

### Modification to Embodiment

According to the fifth embodiment described above, information representing a high-resolution region is superimposed only in a state in which the checking is being performed. However, information representing a high-resolution region may be superimposed in a state in which the capturing is being performed.

According to the fifth embodiment, the state determining unit 401 determines that the current state of the information processing apparatus is a state in which the checking is being performed in the case where the start instruction for the screen capture is given during the viewing, and the state determining unit 401 determines that the current state is a state in which the capturing is being performed in the case where the start instruction for the screen capture is given during the checking. However, a method of determining the current state based on the presence or absence of the start instruction for the screen capture is not a limitation. For example, in the case where the start instruction for the screen capture is given during the viewing, it may be determined that the current state is a state in which the capturing is being performed. In this case, a state in which the checking is being performed is skipped, and the screen capture is immediately started.

According to the sixth embodiment described above, the instruction UI is superimposed, and the user gives an instruction for changing a rendering setting or the start instruction for the screen capture by using this. However, a user instruction method is not limited thereto. For example, an instruction may be assigned to a button or stick of a controller, and the user may give the instruction by using this. In this case, the instruction UI may not be superimposed at S1904.

The present disclosure can be provided by performing processing in which a program that fulfills one or more functions according to the embodiments described above to a system or a device via a network or a storage medium, and one or more processors of a computer of the system or the device read and run the program. The present disclosure can be provided also by a circuit (such as an ASIC) that fulfills one or more functions.

The embodiments described above are specifically described by way of example to carry out the present disclosure, but the technical range of the present disclosure is not restrictively interpreted because of these.

That is, the present disclosure can be carried out in various ways without departing from the technical idea thereof or main features thereof.

According to the present disclosure, difficulty in image viewing in the case where screen capture is performed can be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-212240, filed Dec. 5, 2024, which is hereby incorporated by reference herein in its entirety.

What is claimed is:

1. An information processing apparatus comprising:
a setting unit that sets a resolution of rendering such that the resolution of rendering differs between a region depending on a line of sight of a user to a screen and another region;
a rendering unit that renders an image to be displayed on the screen, depending on the resolution of rendering that is set by the setting unit; and
a state determining unit that determines whether capturing of the image that is displayed on the screen is being performed,
wherein in a case where the state determining unit determines that the capturing is being performed, the setting unit cancels a setting of the resolution of rendering for the region depending on the line of sight of the user and the other region and sets the resolution of rendering for a specific region on the screen at a predetermined resolution.

2. The information processing apparatus according to claim 1,
wherein the setting unit sets the resolution of rendering for another region other than the specific region at a resolution lower than the predetermined resolution.

3. The information processing apparatus according to claim 1,
wherein setting the resolution of rendering such that the resolution of rendering differs between the region depending on the line of sight of the user and the other region is performed in a manner in which foveated rendering in which the line of sight is tracked is set by the setting unit.

4. The information processing apparatus according to claim 1,
wherein in a case where the state determining unit determines that the capturing is being performed, setting the resolution of rendering for the specific region on the screen at the predetermined resolution is performed in a manner in which fixed foveated rendering is set by the setting unit.

5. The information processing apparatus according to claim 1, further comprising:
a load acquiring unit that acquires a processing load of the rendering,
wherein in a case where the state determining unit determines that the capturing is being performed, the setting unit further sets a rendering angle of view, based on the processing load of the rendering.

6. The information processing apparatus according to claim 5,
wherein the load acquiring unit acquires the processing load of the rendering, based on a number of calculations of the rendering.

7. The information processing apparatus according to claim 5,
wherein the setting unit sets the rendering angle of view such that the rendering angle of view is narrowed with an increase in the processing load of the rendering.

8. The information processing apparatus according to claim 5,
wherein in a case where the state determining unit determines that the capturing is being performed, the setting unit sets, as the specific region on the screen, a region in which fixed foveated rendering is performed at a high resolution and sets a range of the region in which the fixed foveated rendering is performed at the high resolution, based on the processing load of the rendering.

9. The information processing apparatus according to claim 5, further comprising:
a mode determining unit that determines whether a mode of the capturing of the image that is displayed on the screen is a moving image capturing mode or a still image capturing mode,
wherein in a case where the mode determining unit determines that the mode of the capturing of the image is the moving image capturing mode, the setting unit sets the rendering angle of view, based on the processing load of the rendering.

10. The information processing apparatus according to claim 1, further comprising:
an output unit that outputs the image that is rendered by the rendering unit in a case where the state determining unit determines that the capturing is being performed.

11. The information processing apparatus according to claim 1, further comprising:
a display unit that generates a display image based on the image that is rendered by the rendering unit.

12. The information processing apparatus according to claim 11, further comprising:
a state providing unit that superimposes, on the display image, information representing that the capturing is being performed.

13. The information processing apparatus according to claim 11, further comprising:
an information providing unit that superimposes, on the display image, information representing the resolution of rendering, information representing a rendering angle of view at execution of the capturing, or both.

14. The information processing apparatus according to claim 13,
wherein the state determining unit further determines whether viewing of the image that is rendered by the rendering unit is being performed by the user, checking of the image to be captured is being performed by the user, or the capturing is being performed, and
wherein in a case where the state determining unit determines that the checking is being performed, the information providing unit further superimposes, on the display image, information representing that the checking is being performed.

15. The information processing apparatus according to claim 14,
wherein the information providing unit further superimposes, on the display image, multiple pieces of check information corresponding to a rendering setting that is configurable by the setting unit.

16. The information processing apparatus according to claim 14, further comprising:
a reception unit that receives an instruction from the user,
wherein in a case where the reception unit receives a start instruction for the capturing from the user, the state determining unit determines that the capturing is being performed, and in a case where the reception unit receives an end instruction for the capturing from the user, the state determining unit determines that the viewing is being performed.

17. The information processing apparatus according to claim 14, further comprising:
a reception unit that receives an instruction from the user,
wherein in a case where the reception unit receives a start instruction for the capturing from the user, the state determining unit determines that the checking is being performed, in a case where the reception unit receives an end instruction for the checking from the user, the state determining unit determines that the capturing is being performed, and in a case where the reception unit receives an end instruction for the capturing from the user, the state determining unit determines that the viewing is being performed.

18. The information processing apparatus according to claim 14, further comprising:
a reception unit that receives an instruction from the user; and
a capturing setting unit that configures a rendering setting at the execution of the capturing in response to the instruction that is received by the reception unit from the user in a case where the state determining unit determines that the checking is being performed.

19. The information processing apparatus according to claim 14, further comprising:
a user interface (UI) providing unit that superimposes, on the display image, a user interface for a user instruction for starting the capturing, for changing a rendering setting at the execution of the capturing, or both in a case where the state determining unit determines that the checking is being performed.

20. An information processing method comprising:
a setting step of setting a resolution of rendering such that the resolution of rendering differs between a region depending on a line of sight of a user to a screen and another region;
a rendering step of rendering an image to be displayed on the screen, depending on the resolution of rendering that is set at the setting step; and
a state determining step of determining whether capturing of the image that is displayed on the screen is being performed,
wherein in a case where the state determining step determines that the capturing is being performed, the setting step includes cancelling a setting of the resolution of rendering for the region depending on the line of sight of the user and the other region and setting the resolution of rendering for a specific region on the screen at a predetermined resolution.

21. A non-transitory computer-readable storage medium storing instructions that, when executed by a computer, cause the computer to perform a method comprising:
a setting step of setting a resolution of rendering such that the resolution of rendering differs between a region depending on a line of sight of a user to a screen and another region;
a rendering step of rendering an image to be displayed on the screen, depending on the resolution of rendering that is set at the setting step; and
a state determining step of determining whether capturing of the image that is displayed on the screen is being performed,
wherein in a case where the state determining step determines that the capturing is being performed, the setting step causes the computer to function as an information processing apparatus that cancels a setting of the resolution of rendering for the region depending on the line of sight of the user and the other region and that sets the resolution of rendering for a specific region on the screen at a predetermined resolution.
